(19) United States
(12) Patent Application Publication
(10) Pub. No.: US 2013/0170378 A1
(43) Pub. Date: Jul. 4, 2013

(54) METHOD AND A SYSTEM FOR LOCALIZATION IN INDUSTRIAL WIRELESS SENSOR NETWORK

(71) Applicant: ABB Research Ltd, Zurich (CH)

(72) Inventors: Apala RAY, West Bengal (IN); Mallikarjun KANDE, Karanataka (IN); Venkateswaran NARAYANAN, Bangalore (IN); Ravish KUMAR, Sitamarhi (IN)

(73) Assignee: ABB RESEARCH LTD, Zurich (CH)

(21) Appl. No.: 13/752,564

(22) Filed: Jan. 29, 2013

Related U.S. Application Data
(63) Continuation of application No. PCT/IB2010/002943, filed on Nov. 18, 2010.

(30) Foreign Application Priority Data
Jul. 30, 2010 (IN) 2163/CHE/2010

(51) Int. Cl. H04W 84/18

(52) U.S. Cl. CPC H04W 84/18
USPC 370/252

(57) ABSTRACT

A method and system are disclosed for localization in an industrial wireless sensor network by identifying a sensor node of a field device for localization, and determining the location information of the sensor node associated with the field device. The determined location information is stored in the field device, in one or more modules of the wireless network management component, and/or an operator portal. Operation can be indicated upon the joining of the field device into the network or during the commissioning of the industrial wireless sensor.

### RELATED APPLICATION

This application claims priority as a continuation application under 35 U.S.C. §120 to PCT/IB/2010/002943, which was filed as an International Application on Nov. 18, 2010 designating the U.S., and which claims priority to Indian Application 2163/CHE/2010 filed in India on Jul. 30, 2010. The entire contents of these applications are hereby incorporated by reference in their entireties.

### FIELD

The present disclosure relates to the field of a Wireless Sensor Network and includes a method and a system for providing a solution for localization in an industrial wireless sensor network.

### BACKGROUND

Generally, a wireless sensor network can be a network of autonomous sensors which are distributed spatially and intended to monitor industrial process variables such as temperature, pressure, etc. Wireless sensor networks have varied applications like object tracking, environment monitoring, industrial monitoring and so on. Wireless sensor networks can have field devices which are wireless devices capable of wireless communication, and may include sensors/actuators, and are connected into the wireless sensor network through corresponding sensor node or mote.

Embedding location information with the information sensed by the sensors in a wireless sensor network can become more useful for various applications such as asset tracking, monitoring etc. Determining the location information of the sensor in a network is termed as localization and this corresponds to the location, position or identification of wireless motes. For instance, network survey information is used to study and characterize the network as a whole. Besides this, reporting the location of the sensor involves localization, and the desire for localization mentioned herein is only exemplary and therefore not exhaustive. There exists various systems and techniques that address concerns related to localization, which may be based on, for example, the Global Positioning System (GPS), Radio Frequency Identification (RFID), etc.

Localization carried out through GPS, RFID, etc in a wireless sensor network, in known ways or forms, may not provide a complete localization solution for an industrial wireless sensor network, because of the non-availability of GPS signals, additional power needed to operate GPS receiver, efficient workflow with support from engineering tools, absence of a method that uses multiple technologies, or such similar limitations. Hence the localization for an industrial wireless sensor network can be quite cumbersome. It is to be effected during commissioning of the network which supports localization using suitable tools and techniques configured or made adaptive to suit the industrial wireless network, or thereafter, and hence is not similar or is a mere extension of the localization as learnt from other applications of a wireless sensor network, which are almost abstract in nature. On the other hand a localization solution after deployment/commissioning, for mobile field devices in an industrial wireless sensor network also has to be considered. In current practice, the localization has not been accomplished in an industrial wireless sensor network owing to the prevailing challenges. Such challenges include addressing localization during or as part of commissioning, employing suitable tools and techniques for localization, effecting localization for indoor and outdoor field devices in a wireless network, and so forth, and these challenges are not trivial.

The present disclosure provides solutions which can enable localization in a wireless sensor network, and which can resolve the above described issues in their entirety.

### SUMMARY

A method is disclosed for localization in an industrial wireless sensor network having one or more field devices, an operator portal, and/or a wireless network management component including one or more modules such as a network manager, a security manager, access points, and/or gateways, the method comprising: identifying a sensor node of a field device for localization by a detection means being the field device, or by one or more modules of the wireless network management component, by a commissioning and configuration unit, by one or more field devices co-located with the field device in the industrial wireless network, and/or by a hand held device; determining location information of the sensor node associated with the field device by a determining means having tools configured in one or more modules of the wireless network management component in the field device, or the commissioning and configuration unit, and/or in the operator portal; and storing the determined location information in the field device, in the operator portal, and/or in one or more modules of the wireless network management component.

A system is also disclosed for localization in an industrial wireless sensor network, the system comprising: one or more field devices which are indoor and/or outdoor; a wireless network management component including one or more modules; an operational portal aiding an operator to operate the network; and means for adapting to and/or configured to function using one or more of techniques and/or tools selected from a group consisting of GPS, RFID, radio frequency beacons, sensor node signal strength, centralized node distance information, time of arrival, and an initial deployment plan of a wireless sensor.

### BRIEF DESCRIPTION OF THE DRAWINGS

Exemplary embodiments will be described with reference to the accompanying drawings in which:

FIG. 1 shows an exemplary system capable of localization in accordance with an exemplary method for localization as disclosed herein;

FIG. 2 shows an exemplary overall workflow involved in the method for localization in accordance with the present disclosure; and

FIGS. 3a-b and 4a-4b depict exemplary determinations of location information of a field device.

### DETAILED DESCRIPTION

A method is disclosed for localization which can be effected during or through commissioning of an industrial wireless sensor network.

A method is also disclosed for localization which can utilize suitable tools and techniques in performing localization.

An exemplary method is disclosed for localization for already deployed field devices and mobile field devices.

A method is also disclosed for localization which can be applied for indoor or outdoor field devices or both.

A system is disclosed for localization in an industrial wireless sensor network, in accordance with the method for localization.

An exemplary industrial wireless sensor network as disclosed herein comprises one or more field devices, operator portals, wireless management components having one or more modules such as a network manager, a security manager, access points, gateways etc, and/or a combination thereof so as to constitute a wireless management component. The field devices may have sensors, and can be connected into the industrial wireless sensor network through sensor nodes also called motes. Each sensor node or mote has a field device associated to it in the network.

Localization can involve determining the location, position and identification of the sensor node and the field device associated therewith. Localization can be performed during or after the commissioning of the industrial wireless sensor network or by using appropriate techniques or tools or by suitable combination thereof either in part or whole. The techniques adopted herein for localization include GPS, RFID, radio frequency beacons, sensor node signal strength, centralized node distance information, time of arrival, an initial deployment plan of the wireless sensor network, and one or more combinations thereof. On the other hand, the commissioning and configuration unit that has tools being used for localization can include hand held devices, operator portals, etc. However, the techniques and tools and the commissioning and configuration unit referred to herein are not comprehensive, and other suitable and appropriate techniques and tools that address the desire or function thereof can be co-extensively applied hereto as will be appreciated by those skilled in the art.

Accordingly, a method is disclosed for localization in an industrial wireless sensor network. The method can include identifying the sensor node of a field device for localization. This can be followed by determining the location information of the sensor node associated with the field device. After determining the location information, the method includes storing the determined location information in the field device or in one or more modules of the wireless network management component, or operator portal, or a combination thereof. The method can be performed during the joining of the field device into the network or during the commissioning of the industrial wireless sensor network or thereafter either in part or in whole.

The identifying of the sensor node or mote of a field device for localization can be made by the field device itself either at the time of joining the network or when triggered suitably to find its location. The field devices either alone or along with any other field devices co-located along with the field device for which the location information is to be determined, can accordingly perform this function. The identification can also be initiated and/or handled accordingly during commissioning of the network or thereafter. In this case, the commissioning and configuration unit having a tool either implicitly or explicitly, such as a handheld device having a tool configured to carry out this function, can be employed for the purpose of the identification. Essentially the means employed as stated herein before can be the detection means for the purpose of an exemplary embodiment.

The determining of the location information of the identified sensor node can be carried out by determining means using suitable techniques and/or tools. The tools may be configured to include a module that can determine the location information of the sensor node. The tool may be employed and/or configured in a handheld device, wireless management component, operator portal, commissioning and configuration unit, etc. The techniques such as GPS, RFID or the like can be successfully employed herein for localization, and can be used independently or in a suitable combination, so as to determine the location information more accurately. For indoor field devices, where GPS cannot be apparently used or used effectively, an antenna that has coverage sufficient to detect the signal, can be used or other suitable techniques can be used for indoor field devices either independently or in combination. Also, it is to be noted that the tools and techniques referred to herein are capable of being used either alone or jointly in proper combination for localization.

Upon determining the location information, the same can be stored in a corresponding field device pertaining to the respective sensor node or in one or more modules of the wireless management component or in an operator portal, or in a combination thereof.

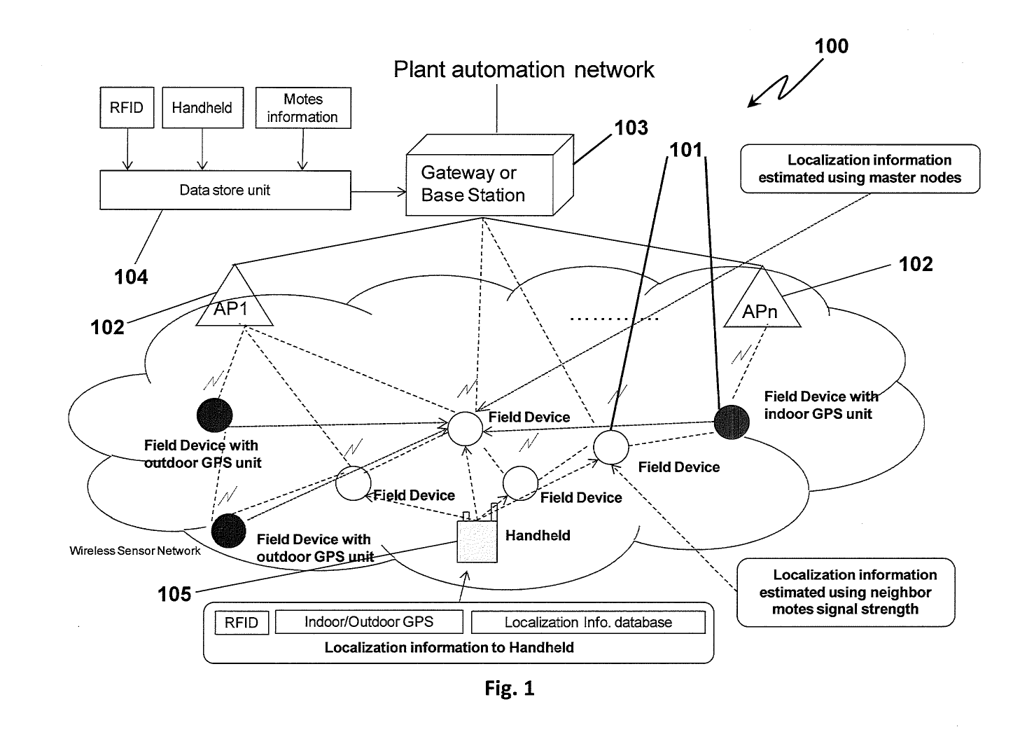

Exemplary embodiments will now be described with reference to the accompanying FIGS. 1 to 4. The embodiments herein after described are only exemplary in nature and not exhaustive. System and methods according to the disclosure relate to the localization of a field device, wherein localization stated here refers to the location information relating to identification of a sensor node, its location and position thereof.

FIG. 1 depicts a system (100) which is capable of localization according to an exemplary method for localization proposed herein. The system in an industrial wireless sensor network can include one or more field devices (101), an operator portal, a wireless network management component, a hand held device (105) and so forth. The field devices may be either indoor or outdoor field devices in the network. Essentially the field devices are connected into the network through sensor node or mote, which means that each field device has a sensor node associated with it. The wireless network management component can include one or more modules such as a network manager, security manager, access points (102), gateways (103), etc. One or more of these modules or their combination constitute the wireless network management component.

The field devices (101) can be connected into the network through access points (102) and gateway (103). The network manager and the security manager mentioned herein manage the network and its security correspondingly with relevance to the function of managing the network and the security thereof.

The field devices, which are outdoor capable of receiving GPS signals can make use of a GPS receiver, and can also use other methods, which are used, where GPS signals are not available. By these means, localization is possible for indoor and outdoor GPS denied environments.

It should be noted that location information can also be sought from the one or modules of the wireless network management component. The location information obtained by and through various means or ways may be stored in a data store unit (104) and used thereafter for such purpose that utilize location information.

An exemplary method for localization is described hereafter by way of exemplary embodiments.

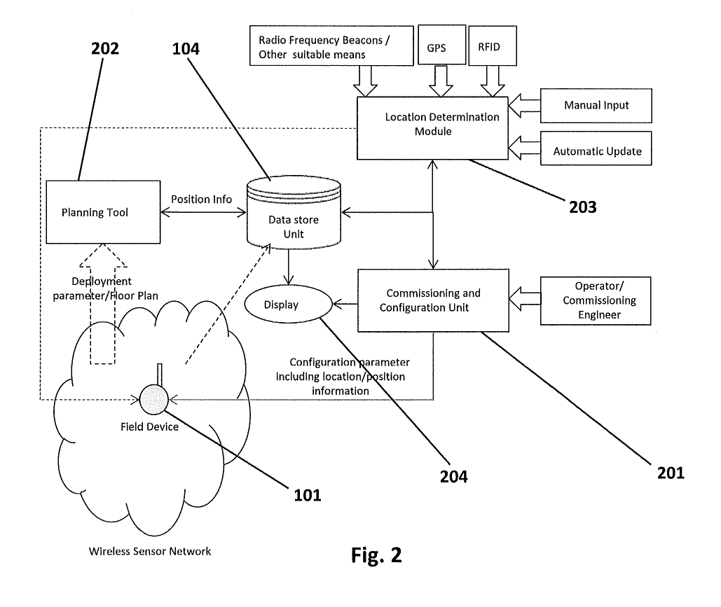

The method for localization is described herein after with reference to exemplary embodiments illustrated through FIGS. 2 to 4. An exemplary method follows steps of identifying the field device whose location information is to be determined. This is followed by determining the location information of the device and storing the location information so determined. The step of storing can coextensively or collaterally include updating the location information wherever applicable and appropriate. This includes updating the location information in the data store unit (104) having explicit or implicit localization database, in one or more modules of a wireless network management component, operator portal, hand held device etc. Various techniques and tools wholly or partially or in combination with other such techniques and tools, can aid in determining and/or effecting localization. Some of the techniques and tools that have been referenced here are those being used in GPS, RFID, short range communication, signal triangulation, radio frequency beacons etc. These are not comprehensive and other possible variations are as well achievable.

Localization can be effected at the time of deploying the field devices based on the floor plan of the industrial wireless sensor network planning tool or by the operator through operator portal or by commissioning and configuration unit during or after the commissioning of the network or by the field device itself or by the other field devices co-located along with the field device.

The location information determined for the field device is updated and/or stored in the data store unit or in one module of the wireless network management component or in the operator portal or in the field device or wherever feasible or in any combination of the above.

FIG. 2 shows overall workflow involved in localization. The field device (101) and the associated sensor node in an industrial wireless sensor network are identified by the detection means. The detection means can be the field device (101) itself, one or more modules of the wireless network management component, commissioning and configuration unit (201), one or more field devices that are co-located along with the field device, hand held device, operator portal etc. The detection means are configured to identify the field device for which localization is to be performed.

If the localization is performed at the time of deployment, the deployment parameter corresponding to the floor plan of the wireless sensor network, including the location information of the field device (101), is included in the planning tool (202) for the network. On the other hand, during commissioning of the network, a commissioning and configuration unit (201) configured to determine the location information is employed.

The step of determining the location information also can include sensing and obtaining relevant parameters/position information manually or automatically as input for determining the location information by the location determination module (203). The input for determining the location information can be obtained by using GPS, RFID, floor plan, signal strength, position distance/information from a wireless network management component, radio frequency beacons and so on or any possible combination thereof. These are some examples for automatic obtaining of the position information being the relevant input. The probable combination of these techniques/tools provides an advantage of utilization of low power as compared to the high power consumption by GPS. It can also be a manual input through a handheld device, pre-stored in a field device, or via a wireless network management component. These inputs are stored in the data store unit (104) and further used for finding out the location information by suitable computation in location determination module (203).

Techniques used in a GPS, RFID or short range communication system or the like attached to the field device (101) sense the position of the field device for determining the location information. The attachment mentioned immediately herein before do not limit to physical attachment only. These techniques can be used independently or in combination appropriately. It is known that a GPS application can be limited to outdoor application, but GPS can be employed for indoor field devices by having an antenna exposed at least minimally to the outside and connecting the same to the GPS, whereby the desired parameters can be reasonably sensed.

These techniques can be used in combination or in hybrid as this will increase the accuracy of the sensed position information. Also, it helps in solving the short comings where a particular technique cannot be used all by itself. For instance, GPS employing an antenna when used for indoor field devices, senses and gives position information which may be reasonably correct, but the same can be further improved for its accuracy, or closer to accurate position information can be obtained by using short range communication, radio frequency beacons, distance information of sensor nodes as well, which further refines the information or takes it closer to accuracy.

The location information is determined by the determining means. The determining means, referenced here can include a tool that has one or more modules configured accordingly or it include one or more modules of the wireless network management component or a commissioning and configuration unit (201) having the tool or the operator portal. These means can be used either alone or jointly in combination.

The location determination module (203) computes the location information based on the relevant inputs having relevance to position information. The location determination module (203) exists within one or more of the following viz. field device (101) or one or more modules of a wireless network management component or commissioning and configuration unit (201) or hand held device or operator portal or the like. The location determination module (203) essentially computes the location information based on certain methodologies which include a triangulation method. The triangulation method or the like may in turn be based on one or more of the signal strength of the field devices, power strength, static position of radio frequency beacons etc.

More specifically, exemplary embodiments can further be described and better understood through forth coming exemplary illustrations.

The position information is obtained automatically from the GPS etc or manually and the same is given as input to the commissioning and configuration unit (201). This input can either become an update for the already existing information, or new, and can become one of the parameters for commissioning. The same is then fed into the corresponding field device through communication interface that may be wired or wireless.

According to another illustration, the GPS attached or integrated to the field device (101) provides the position information and the same is used to determine the location information by the localization module within the field device or the position information can be passed on to the data store unit (104) where location information is determined. Here, the field devices (101) may be outdoor or indoor. In the event of the field device being located indoor, an antenna having been connected to the GPS can be installed accordingly so as to get reasonably exposed to outside enabling detection of position information.

In accordance with another illustration, the field device with position information for determining location information provides the position information to the location determination module (203). In the industrial wireless sensor network, a sensor node with location information can be defined as a master node. The master nodes can have position/location information and their position is conducive to become a reference for determining location of the other sensor nodes in the network. The location information is determined in the location determination module (203) and thereby stored in the data store unit (104). The position information is obtained using GPS, RFID tags with relevant data stored, manual update, techniques employing three master nodes with GPS or signal strength etc. The location determination module (203) referenced here above is available in one or more wireless network management components or field devices (101) or commissioning and configuration units (201).

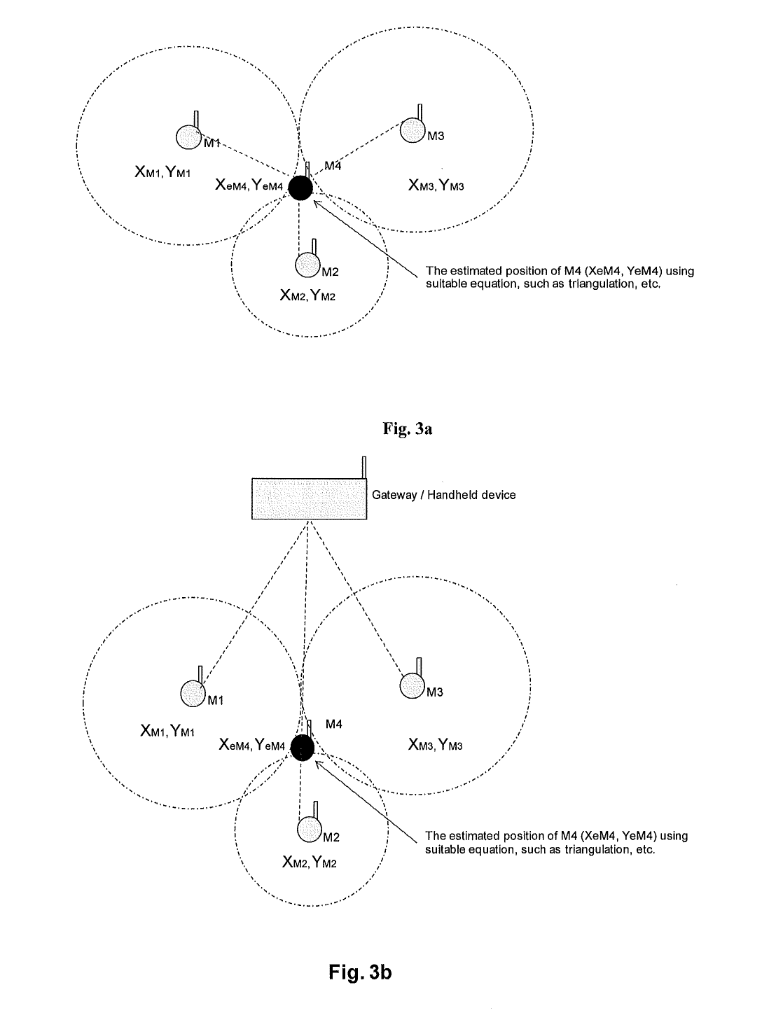

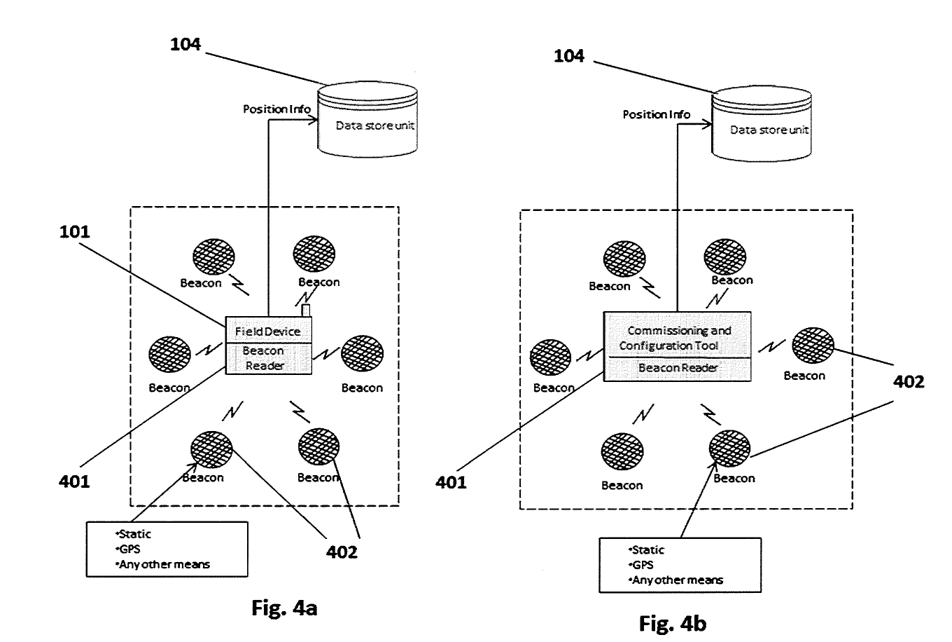

The technique employed to determine position information can be based on a triangulation method using signal strength. This is illustrated in FIGS. 3a and 3b. In FIG. 3a, the field device (101) or the sensor node (mote) associated with it represented as M4 having joined the network can find its location information. M4 has information regarding position and signal level/strength and battery power of the neighbouring field devices and its corresponding sensor nodes (motes) M1, M2 and M3. M4 determines the location information using the information available with it as stated above by triangulation. The determined location information can be updated and/or stored in the field device associated with M4. Similarly, in FIG. 3b, the gateway or the handheld device here has the information relating to the position and signal level/strength and battery power of the field devices and its associated sensor nodes M1, M2, M3 and M4. The gateway or the hand held device determines the location information.

From FIG. 4a it can be seen that the field device (101) fixed with a radio frequency beacon (401) reads the position information of the beacons (402) installed in the network by GPS or other possible means. Then, the location information is determined as described herein before. Similarly, in FIG. 4b it can be seen that the radio frequency beacon (401) can be oriented with commissioning and configuration unit (201) also. The location information so determined is updated and/or stored in the data store unit (104).

Accordingly, the commissioning and configuration unit (201) after obtaining the location information pertaining to a field device (101) from the data store unit (104) or GPS etc can write the location information into the RFID tag of that device using an RFID writer. By this also, the location information can be loaded into the field device (101).

It should be noted that techniques and tools mentioned herein above throughout the description are not restricted to one particular method or practice and can be suitably and appropriately extended or used in conjunction with one or more elements of the system or vice versa in all probable combinations thereof in the industrial wireless sensor network. Such modifications, variations or improvements therein are construed to be within the scope of the invention though not explicitly mentioned.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

We claim:

1. A method for localization in an industrial wireless sensor network having one or more field devices, an operator portal, and/or a wireless network management component including one or more modules such as a network manager, a security manager, access points, and/or gateways, the method comprising:
identifying a sensor node of a field device for localization by a detection means being the field device, or by one or more modules of the wireless network management component, by a commissioning and configuration unit, by one or more field devices co-located with the field device in the industrial wireless network, and/or by a hand held device;
determining location information of the sensor node associated with the field device by a determining means having tools configured in one or more modules of the wireless network management component in the field device, or the commissioning and configuration unit, and/or in the operator portal; and
storing the determined location information in the field device, in the operator portal, and/or in one or more modules of the wireless network management component.

2. The method as claimed in claim 1, wherein the identifying comprises:
manual or automatic identification of the said sensor node by the one or more detection means configured to identify the field device for which localization is to be performed.

3. The method as claimed in claim 1, wherein one or more of the said detection means comprises:
techniques and/or tools which involve GPS, RFID, radio frequency beacons, sensor node signal strength, centralized node distance information, time of arrival, GPS with antenna, and/or an initial deployment plan of a wireless sensor network.

4. The method as claimed in claim 1, wherein the determining of the location information by determining means, comprises:
determining the location information based on signal strength, three master nodes, radio frequency beacons and/or a triangulation technique.

5. The method as claimed in claim 4, comprising:
receiving information relating to determining the location information, for determining location information, from the one or more of said detection means, and/or from a data store unit where information for determining the location information is being stored exclusively or inclusively.

6. The method as claimed in claim 1, wherein the storing of the determined location information comprises:
updating and/or storing the location information so determined in one or more of field devices, one or more modules of the wireless network management component, the operator portal, and/or the hand held device.

7. The method as claimed in claim 1, comprising:
displaying the location information and the information for determining the location information.

8. The method as claimed in claim 1, being performed when a field device joins the network, or during commissioning of the network or thereafter, either in part or whole.

9. A system for localization in an industrial wireless sensor network, the system comprising:
one or more field devices which are indoor and/or outdoor;
a wireless network management component including one or more modules;
an operational portal aiding an operator to operate the network; and
means for adapting to and/or configured to function using one or more techniques and/or tools of selected from a group consisting of GPS, RFID, radio frequency beacons, sensor node signal strength, centralized node distance information, time of arrival, and an initial deployment plan of a wireless sensor.

10. The system as claimed in claim 9, comprising:
displaying means for displaying the location information and the information for determining the location information.
